(19) United States
(12) Patent Application Publication
(10) Pub. No.: US 2001/0050681 A1
(43) Pub. Date: Dec. 13, 2001

(54) Method and system for creating and delivering electronic, multi-media presentations

(75) Inventors: Daniel Scott Keys, Denver, CO (US); Troy Philip Lerner, Denver, CO (US); Maureen Anna Keys, Denver, CO (US); Marc Chipouras, Boulder, CO (US); David Alan Kittle, Highlands Ranch, CO (US); Leonard Alan Eckstein, Denver, CO (US); Benjamin Rupert Hadwen, Denver, CO (US); Naomichi Ishibashi, Denver, CO (US)

Correspondence Address: MERCHANT & GOULD PC, P.O. BOX 2903, MINNEAPOLIS, MN, 55402-0903, US

(73) Assignee: i-Media World.com

(21) Appl. No.: 09/822,654

(22) Filed: Mar. 30, 2001

Related U.S. Application Data
(60) Provisional application No. 60/193,780, filed on Mar. 31, 2000.

(51) Int. Cl. G06T 1/00

(52) U.S. Cl. 345/418

(57) ABSTRACT

A system and method of generating an electronic graphical presentation on a computer system. A sample template is displayed and the user chooses one such sample template. An interactive web page, i.e., an editor template, that looks similar to the selected sample template and has editable fields is displayed and edited. The supplied information is then used to generate a final presentation that is then delivered to the user. The editor template is created to look substantially similar to the sample template, such that the editable fields occur in the area wherein the actual information will ultimately be displayed to aid the user in visualizing the final product.

### RELATED APPLICATIONS

The present application claims the benefit of, and hereby incorporates by reference, U.S. Provisional Patent Application 60/193,780, entitled METHOD AND APPARATUS FOR CREATING AND DELIVERING ELECTRONIC, MULTI-MEDIA PRESENTATIONS, filed Mar. 31, 2000.

### TECHNICAL FIELD

The present invention relates generally to the creation of electronic presentations, and more particularly to the simplification of creating these presentations using available medium, such as the Internet.

### BACKGROUND OF THE INVENTION

In today's competitive environment, businesses spend considerable time and effort in advertising and otherwise presenting themselves to others in a professional manner so as to create a favorable impression. Many businesses employ whole internal departments or outside firms that provide the service of creating professional-looking presentations for various meetings, sales pitches, and general marketing. The presentations are often in the form of executable files or files that can be viewed using other software applications and these files are saved or burned on to compact disk (CD) memory devices. Moreover, the presentations are typically multimedia productions combining text, graphics, audio, video, animation and other features such as executable links and other program interaction. Typical software applications used to view presentation files include Microsoft® PowerPoint® presentation graphics software, HTML browsers or Flash® software to view “.swf” files (Shockwave Format).

Once the presentation file is saved, businesses can either execute the file while making presentations to others, hand out the CDs storing the file at promotional functions, or host the file on a server as a Web site. Recipients of the CD need only put the CD into a personal computer and the executable file runs thereby facilitating the presentation to the recipient. This method of advertising has proven to be a valuable means of reaching various users in a professional manner.

The creation of these presentations is a fairly complicated process of programming with a software tool or collection of several software tools that generate the presentation. Indeed, there is a significant learning curve associated with developing a high level presentation using these tools. Therefore, in order to create a professional-looking presentation, businesses are forced to decide between hiring an outside firm at a considerable price or spending the additional time and energy learning a software product, e.g., presentation-creation software applications, such as Macromedia Flash® or PowerPoint® presentation graphics programs.

Although there may always be a place for outside firms to provide high-quality, customized presentations for businesses, many companies simply cannot afford the time or money associated with these options. Even if cost is not the primary concern, the outside firms generally take considerable time to put together the presentation such that when timing is important, the outside-firm option may not be acceptable solution. Similarly, even if someone was capable of working with one of the high-level presentation software products, it still may take considerable time to produce a final product.

Another drawback associated with purchasing a software program involves porting the final product to a format that is acceptable. For example, if using PowerPoint®, the end product is a PowerPoint® presentation that must be run on PowerPoint®. Indeed, if the presentation were handed out at a promotional function, the recipients would need the PowerPoint® viewer software to execute the program.

Moreover, the cost associated with purchasing more sophisticated programs is relatively high. If a company is going to construct a single presentation, the cost associated with purchasing complex software outweighs the benefit of having the software.

Yet another drawback with purchasing software or using an outside consultant occurs when a presentation needs to be put together or modified and the software or consultant is in another location, e.g., when the person is traveling.

It is with respect to these and other considerations that the present invention has been made.

### SUMMARY OF THE INVENTION

The present invention provides a method and system of creating a high-quality presentation using the Internet. The creation process may be purchased on a pay-per-project basis or by way of yearly subscription. An aspect of the invention relates to providing the easily accessible web-site on the Internet that guides the user through the payment and data collection phase of the process. Another aspect of the invention relates to the generation and storage of many different “blank” presentations, i.e., templates that the user may choose from for creating their own presentation. Moreover, a template may be custom designed for a particular client. Another aspect of the present invention relates to the collection of presentation information from the user, and compiling this information to create a high-quality presentation. Yet another aspect of the present invention relates to the creation of the actual presentation, on a server computer system. Another aspect of the invention relates to the final disposition of the completed presentation in various formats to the customer via the Internet.

In accordance with these and other aspects, the present invention relates to a system and method of generating an electronic graphical presentation on a computer system comprising the acts of displaying a plurality of sample templates, each sample template showing a possible presentation layout; receiving a request to begin editing a selected one of the sample templates; displaying an editor template, the editor template looking similar to the selected sample template and having editable fields; receiving project information from a user; storing the project information in a database relative to the editable fields of the editor template; and supplying the received information to generator software to automatically create a presentation based on the information and the selected sample template. Additionally, the invention relates to performing this method on a client-server computer system having a client computer system and server computer system that communicate over a distributed network and wherein the user operates the client computer system.

In accordance with certain aspects, the invention relates to creating an interactive web page that has editable fields, i.e., and editor template, wherein the editor template looks substantially similar to a final presentation, is stored in the database, and is associated with a sample template that may be selected by the user. The editor template is displayed following user selection of the associated sample template, and as editable fields that allow the user to enter data in the area wherein the information will appear in the final presentation. The entered information relates to project information and is stored in the database in a project profile. The generation of the final presentation relates to combining the template information with the project profile information to generate a final presentation that may be in an executable file such that the user can execute on a computer system.

In accordance with other preferred aspects of the present invention, various forms of the presentation are available to the user, e.g., an executable file may be emailed to the client computer system or downloaded to the client computer system, such as by using HTTP (Hyper Text Transfer Protocol). Alternatively, a Shockwave formatted file or other type of file may be created and used by the client, such as being incorporated into a web page. Moreover, since the presentation is created remotely from the user, the user may choose other options such as having the presentation saved to a CD, which is then shipped to the user. Additionally, the presentation may be saved to many CDs, e.g., 25-500 or even mass-produced using a mass-replication process. Additionally, the CDs can be customized both in shape and artwork prior to shipping, etc.

These and various other features as well as advantages, which characterize the present invention, will be apparent from a reading of the following detailed description and a review of the associated drawings.

### BRIEF DESCRIPTION OF THE DRAWINGS

FIG. 1 is a pictorial representation of an exemplary environment incorporating a server computer system in an embodiment of the invention.

FIG. 2 is a block diagram of an exemplary computer system and some of its components.

FIG. 3 is a block diagram of the various elements used to create a presentation.

FIG. 4 is a flowchart of operations for creating a presentation, including both editing and processing operations.

FIGS. 5-9 illustrate a more detailed flowchart of a particular embodiment of operations for creating an electronic graphical presentation.

### DETAILED DESCRIPTION OF THE INVENTION

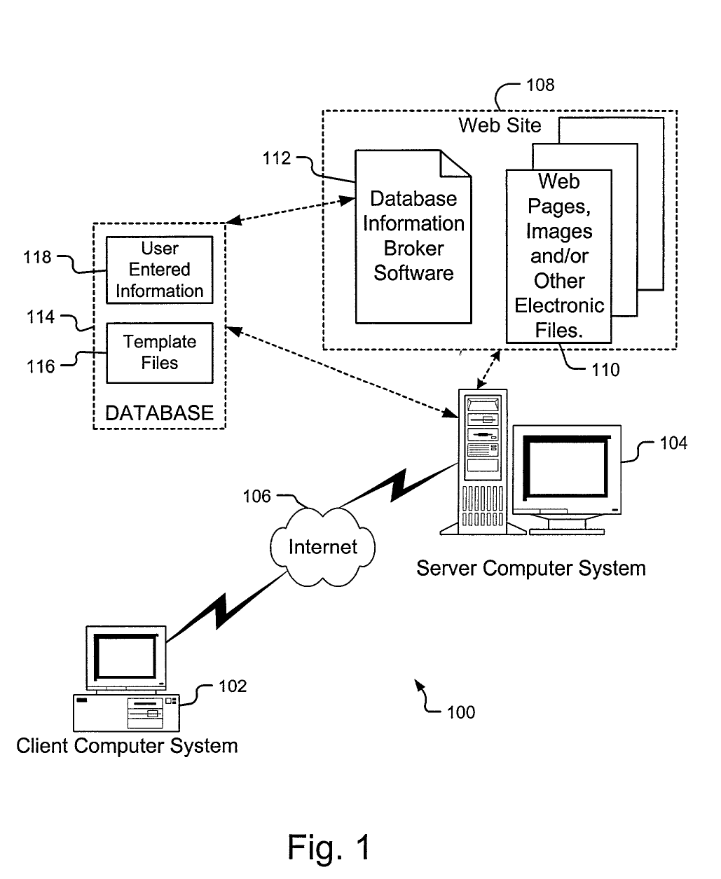

Embodiments of the invention described herein are implemented as logical operations in a distributed processing system or network 100 having a client computer system 102 and at least one network or web server computer system 104, as shown in FIG. 1. The logical operations of the present invention are implemented (1) as a sequence of computer implemented steps running on either or both of the computing systems 102 and 104 and (2) as interconnected machine modules within the computing network 100. The implementation is a matter of choice, dependent on the performance requirements of operations making up embodiments of the present invention described herein are referred to variously as operations, steps and/or modules.

In the client-server environment 100 shown in FIG. 1, the client computer system 102 runs a browser module (hereinafter browser) on the computer 102 for retrieving or browsing electronic documents from a remote server computer 104. The illustrated remote computer network 106 is the Internet. In the illustrated client-server environment 100 the client computer system 102 connects to the computer network 104 over a telephone line with a modem (not shown). Other alternative connections can be used such as a network interface, an ISD1, T1 or the like high speed telephone line, a television cable, a satellite link, an optical fiber network, an Ethernet or local area network technology wire and adapter card, or radio, optical or other wireless transmission devices, etc. The invention can alternatively be embodied in a client-server environment for other public or private computer networks, such as a computer network of a commercial on line service or an internal corporate local area network (LAN) or like computer networks.

The server computer system 104 hosts a web site 108 having web pages and other items 110 (hereinafter collectively referred to as “electronic documents”). In conformance with HTML, the electronic documents 110 can incorporate other additional information content, such as images, audio video executable programs, etc., (hereinafter collectively referred to as “images,”) which may also reside at the remote computer 104. The electronic document and images are stored as files in a file system of the remote computer 104.

The web site 108 on the server computer system 104 also incorporates information broker software 112, such as Active Server Pages (ASP) which may be used to receive information from the user and store that information in a database, such as database 114. Additionally, the information broker software 112 may also pull information from the database 114 so the web site may present particular information to the user as discussed below.

In one embodiment the database 114 is located on the remote computer 104. In other embodiments, the database is not necessarily a part of the computer 104, but may be accessed by computer system 104 such that computer system 104 may both access stored information and store other information to the database 114. The database comprises both template files 116, i.e., predetermined data files used to generate a visual indication of a final presentation, without any user information. The database 114 also comprises user entered information 118, i.e., information that has been entered by users and that may be combined with template information to create a final presentation.

In an embodiment, a user operates the client computer system browser to access the web site 108 on the server computer system over the Internet 106, and displays at least one of the documents 110 on the computer screen or output device as part of the client computer system 102. The browser utilizes a graphical interface, generating a display area on the screen of the computer's output device as is conventional in an operating system with a graphical user interface. Through the use of the graphical user interface, the user exchanges information with the server computer system via network 106 to create an electronic multimedia presentation document.

In order to facilitate the exchange of information, the server computer system 104 provides the information broker software 112, such as in the form of an interactive web page that requests information from the user, and in response, the user is able to supply the requested information. The server computer system 104 is able to store information received from the user and use the information to process, i.e., generate new presentation files using the information received. In an alternative embodiment, the server computer system 104 transmits information to the client computer system 102, such that the bulk of the processing is completed on the client computer system 102.

In a particular embodiment of the invention, the web page information broker software 112 utilizes Active Server Pages (ASPs) that provide the requisite interaction between the client and the server computers and the database 114. An ASP transfers information that the user enters into either an HTML page or a Flash object (or any other data gathering object) to the database 114 associated with computer 104. For example, a user may enter their name in a text box on an HTML page and then enter a command to “save” their name into the database 114. The save command is interpreted by the ASP to retrieve the data from the HTML slot identified as the user's ‘name’ and deliver this data to the database 114, storing it in a field called ‘name’ which is part of user information 118. Further, assume the user selects another command related to viewing information such as ‘preview’. This user request commands the ASP to retrieve data from the database and from the field called ‘name’ and deliver it to an HTML page and put it in the slot called ‘name’. Essentially, the ASP is an information broker between database and input interface. More specifically, the ASP converts data to and from comma delimited files and delivers the data from an input object, e.g., like HTML, to a database, or from a database to an input object. Moreover, the ASP of the present invention interfaces with template files that store the various types of presentations that a user may select, as discussed in more detail below.

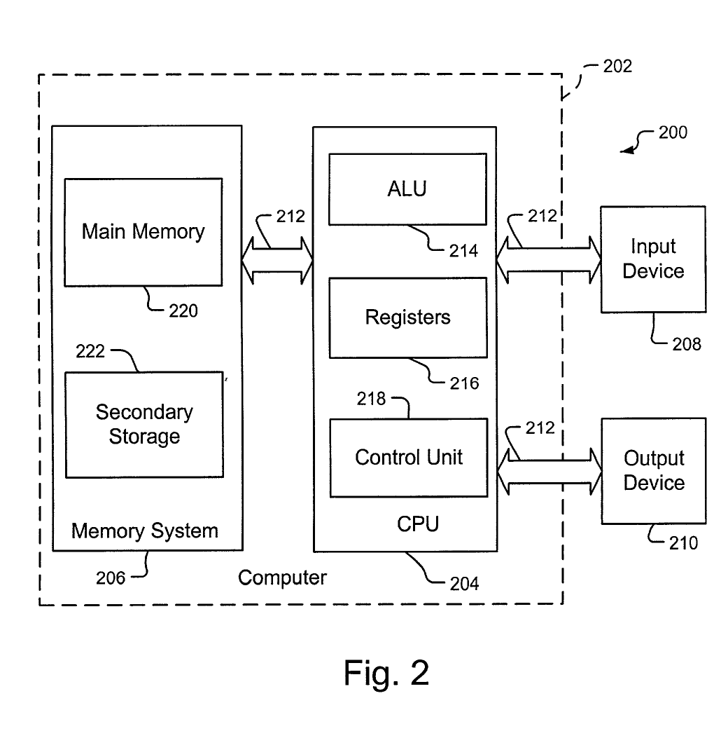

A suitable computing environment in which the invention may be implemented is shown in FIG. 2. Although, not required, the invention is described in the general context of computer executable instructions such as program modules being executed by a personal computer (PC). Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, micro-processor based or programmable consumer electronics, network PCs, mini computers, main frame computers and the like. These different computer types may also operate using different operating systems, such as Linux operating system, Microsoft® Windows® operating system, etc. The invention may also be practiced in distributed computing environments where tasks are performed by remote processing devices that are linked through a communications network in a distributed computing environment, program modules may be located in both local and remote memory storage devices.

An exemplary computer system 200 for implementing the invention is shown in FIG. 2. The computer system 200 incorporates a computer 202 in the form of a portable or desktop computer system that comprises at least one central processing unit (CPU) 204, a memory system 206, an input device 208, and an output device 210. These elements are coupled by at least one system bus 212.

The CPU 204 is of familiar design and includes an Arithmetic Logic Unit (ALU) 214 for performing computations, a collection of registers 216 for temporary storage of data and instructions, and a control unit 218 for controlling operation of the system 200. The CPU 204 may be a microprocessor having any of a variety of architectures including, but not limited to those architectures currently produced by Intel, Cyrix, AMD, IBM, DEC and Motorola.

The system memory 206 comprises a main memory 220, in the form of media such as random access memory (RAM) and read only memory (ROM), and a secondary storage 222 in the form of long term storage mediums such as hard disks, floppy disks, tape, compact disks (CDs), flash memory, etc. and other devices that store data using electrical, magnetic, optical or other recording media. The main memory 220 may also comprise video display memory for displaying images through the output device 210, such as a display device. The memory 206 can comprise a variety of alternative components having a variety of storage capacities such as magnetic cassettes memory cards, video digital disks, Bernoulli cartridges, random access memories, read only memories and the like may also be used in the exemplary operating environment. Memory devices within the memory system 206 and their associated computer readable media provide storage of computer readable instructions, data structures, program modules and other data for the computer system 202.

The system bus 212 may be any of several types of bus structures including a memory bus or memory controller, a peripheral bus, and a local bus using any of a variety of bus architectures.

The input and output devices 208 and 210 are also familiar. The input device 208 can comprise a keyboard, a mouse, a microphone, etc. The output devices 210 can comprise a display, a printer, a speaker, etc. Some devices, such as a network interface or a modem can be used as input and/or output devices. The input and output devices 208 and 210 are connected to the computer 202 through system buses 212.

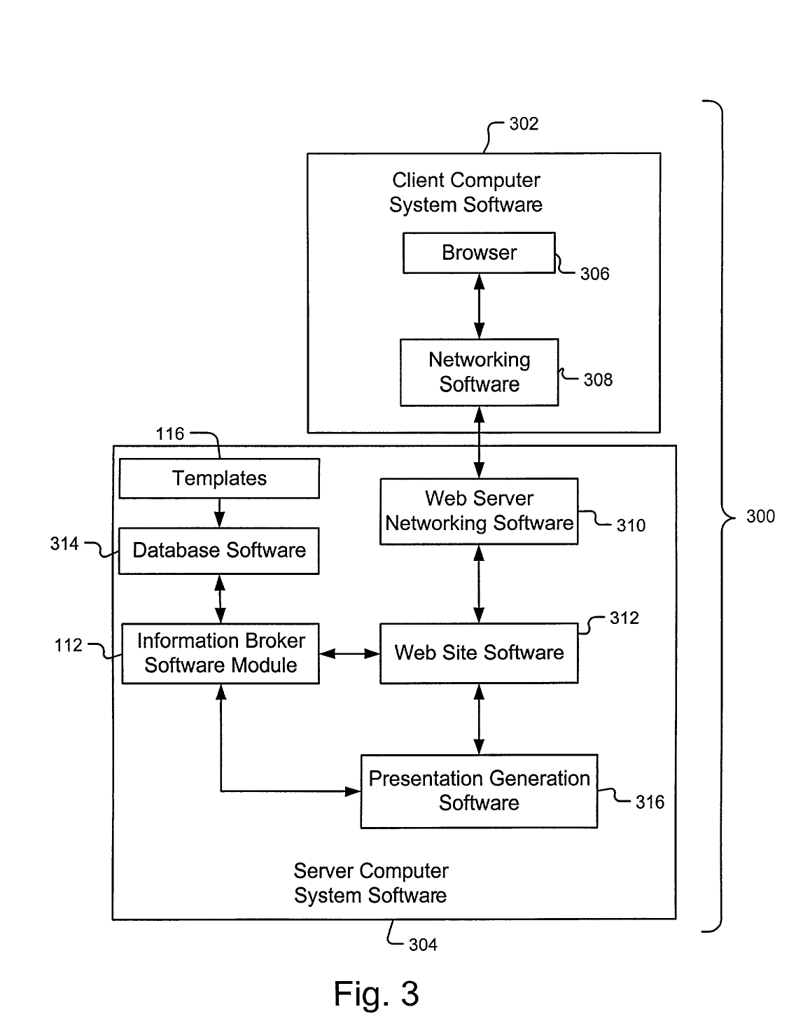

A software operating environment 300 within the client-server environment 100 (FIG. 1) for practicing the present invention is shown in FIG. 3. The software environment 300 includes the interaction between a software system 302 operating on client computer system 102 (FIG. 1) and a software system 304 operating on server computer system 104 (FIG. 1). The software system 302 comprises many software tools including a browser module 306, which provides navigational functionality on the network system, e.g., the Internet 106 (FIG. 1). The client computer software system 302 also has networking software 308 that implements networking protocols for communicating on the Internet 106 thus indirectly with a network server software module 310, which is part of the server software system 304. The browser 306 communicates with the networking software 308 using a set of application programming interfaces (APIs) of operating system functions and services to retrieve the electronic documents from the web server 104 (FIG. 1).

The server computer system software 304 comprises the networking software 310 and, in addition, web site software 312. The web site software 312 provides overall control and basic flow of the web site 108 (FIG. 1). The web site software uses information broker software 112 to display information to the user and receive information from the user.

The template files 116 are prepared containing specific information related to a type of presentation. In essence, the template files contain all the necessary information, but for the user specific information, to create a relatively high-level presentation. The user or presentation specific information is stored in a database 114 (FIG. 1) through interaction between data by software 314 and the information broker software 112.

Also located on the server computer system is the networking software 310 and presentation generation software 316. Once the user enters the user specific information, that information is combined with the selected template information and delivered to the presentation generation software. The generation software 316 manipulates and compiles the received information into a high-level multimedia file. In one embodiment, the generator template leverages ASP to populate the template with user provided data for final format generation, such that the ASP does not do the processing. The generator then creates a final formatted multimedia product that is available for final disposition. In an embodiment of the invention, the generator 316 can produce several formatted multimedia products. In one case, the generator produces an executable file (.exe file) for CDs or download, a Shockwave file (.swf file) for the web and a Shockwave file (.swf file) for preview. The files that are created by the generator are typically not modified after generation. However, in other embodiments, the files could be further modified by something other than the generator.

The final product is conducted back to the user through the networking software 310 and 308.

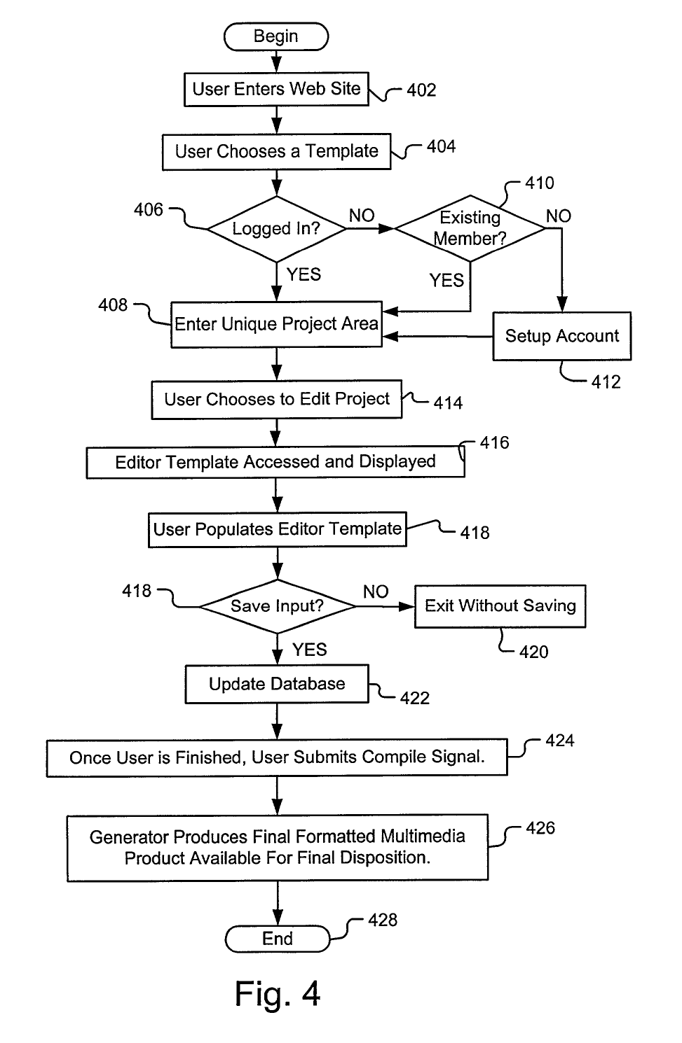

FIG. 4 depicts the operational flow of the present invention. Initially, the process 400 begins when the user enters the web site at 402. Once the user has entered the web site, the user then selects or chooses a template. In a preferred embodiment, the user can browse through a gallery of available sample presentations or templates, allowing the user to view different options and experience editing the template in the editing interface. Each different option is a different type of presentation, each having different features. For example, the types of colors or graphics to be used, whether still slides or animation is used, and whether audio is going to be used, as well as other features and design preferences. The template may either provide single options that contain predetermined graphics, animation and audio components, or the templates may provide portions, allowing the user some choices in terms of mixing and matching the various components. The template may also allow the user to upload information such as custom images, video, or audio.

In an alternative embodiment, the system may have a custom designed template for a particular user. Once the user logs in or otherwise verifies their identification, that user may access the custom-designed template. In this embodiment, only predetermined clients or users are able to access certain custom templates.

As discussed above with respect to FIG. 1, each template is stored in a separate file in the database. Typically, the template file is merely a data file. During the display of a template, i.e., while the user is browsing the gallery, the data in the template file is processed into an .swf (Shockwave Format) file that the web page software 312 executes to display the presentation in generic form (without user specific information.) Alternatively, each template can provide its own, pre-compiled executable file that is executed at display time so as to demonstrate how a compiled presentation may look when completed. There may be at least two types of templates, preview templates that merely provide the user an idea of the presentation layout but do not allow for any editing and editor templates that have editable fields that allow the user to enter specific user information.

Following choose operation 404 wherein the user chooses a template, determine operation 406 determines whether the user has logged in. Essentially, once the user enters the web site, one option may be to log in prior to selecting a template. If the user has logged in, then flow branches YES to enter operation 408, which is described in more detail below. If, on the other hand, determination operation 406 determines that the user has not logged in, then flow branches NO to a second determination act 410 that determines whether the user is an existing member. For example, by entering a login or user name and password, the determination act may determine whether an account has already been set up for this user.

If determination act 410 determines that the user is an existing member and has performed the requisite login steps, then flow branches YES to enter operation 408. If the determination act 410 determines that the user is not an existing member then flow branches NO to setup account operation 412. Setup account operation 412 allows the user to set up an account and login accordingly. Following setup operation 412 flow branches to enter operation 408.

Of course, other embodiments may not incorporate such a login procedure. However, for the embodiment that uses custom designed templates for certain customers, then those templates must be accessed following a login-type procedure. If the user is not logged in and does not have a user profile stored on the system, a profile may be set up at this time. Thus, the next time the user accesses the system, the user is able to simply log in and proceed to the next step. Moreover, the login procedure helps users keep personal profiles so that information may be stored and retrieved at a later time.

Once the user selects a template at step 404 and has logged in, a copy of source files may be transmitted to the user environment to improve the performance by having a portion of the processing take place using the client computer system. In alternative embodiments however, the source files remain at the server computer system and are not transferred to the client computer system. In some situations, leaving the source files at the remote server computer system, performance may be enhanced.

Next, the enter operation 408 allows the user to enter the online software interface, i.e., the unique project area. The unique project area relates to the graphical user interface that the user will create the presentation of choice by providing specific user information through the use of the interactive web site and the information broker software. Typically, at this point, the user may choose, at operation 414, to edit a project. The project may be a new project based on the selected template, or the project may actually be based on a previously recorded presentation.

Following choose operation 414, access operation 416 accesses an editor template and displays this editor template for the user. The editor template has been created prior to this stage, and access operation 416 accesses the editor template from memory, e.g., the database. Importantly, the display at the client side computer is substantially similar to that of what the actual display will look like such that the user can see what the information will look like once the process is complete. That is the editor template mimics the look of the template that will be used for the final presentation. Additionally, input boxes are positioned such that they mimic the placement of objects in a compiled presentation to aid the user in determining how the final product will look.

Following creation and display of the editor template, populate operation 418 populates the editor template. That is, at operation 418, the user enters text or other assets, e.g., images, sounds, etc. on the editor template that mimics the look of the template via editable objects on the .swf (Flash) template. In addition to adding text at 418, the user may also make other decisions including the following: audio track choices, background image choices, image choices (not all images are uploaded), and other choices. Entering text and other multimedia assets into a template having high-end presentation features and characteristics provides the user with a relatively simple means of creating a personalized high-end presentation without needing expertise in advance programming languages. In essence, much of the learning time associated with creating a presentation is reduced since the assets are entered a “what you see is what you get” (WYSIWYG) manner so that the user doesn't directly deal with code or advanced programming languages in creating a multimedia product.

Following population of the editor template, detect operation 418 detects whether the user wants to save the information. If not, flow branches NO to exit without saving operation 420 causes the entered information to be lost. If the user wants to save the information, as detected by the operation 418, then flow branches YES to update database operation 422. Detecting whether the user wants to save information is based on receiving the proper signal from the user.

Update operation 422 updates the database with the new input information from the user. Typically, this information maybe saved using the information broker software, e.g., ASP, which delivers information to the database for storage. Thus, as the user provides the presentation specific information, update operation 422 updates the presentation record for later processing. The information is preferably stored relative to its final location.

Following the storing of the user presentation information, the user provides a signal to the server that all editing is complete at operation 424, thereby signifying to the server that the generation of the presentation file can begin. At this point, the user may want to preview the information that has been stored, or the user may request a compiled version to be displayed. Typically however, the user may eventually go back and continue to edit the presentation until complete.

Upon receipt of the signal at operation 424, the data from the client and the template information is combined and delivered to the generator module at operation 426. The generator module is the application that receives the data and compiles it into a high-quality multimedia electronic presentation.

The generator, in an embodiment, is third party software called Macromedia Generator Server 2.0 which can generate both .swf and .exe files and includes elements of high-quality multimedia. In another embodiment, the generator named Turbine produced by Blue Pacific could also be used. In yet other embodiments, other generators could be used. With respect to the Macromedia Generator, it requests that certain variables are provided in order to generate a presentation file. The editor template, i.e., the graphical interface that mimics the corresponding template stored in the database is used to collect these variables from the user which are then delivered to the database via ASP (or other information broker software) as a comma delimited file. When the command is given to create a final product, the ASP delivers this data to the Macromedia software (or other generator software) which then compiles the raw data with the template information and produces the final product.

In an embodiment, a compiled presentation is produced that allows the user to view the final product, yet the compiled presentation is not necessarily in its final format. That is, a .swf file is created and displayed to the user with all their information. However, the .swf file may not be the final format for downloading to the user, e.g., the user may get a .exe file. This conversion is fairly straightforward. That is, the chosen template is a .swt (Shockwave Template) that works in the generator to call assets, i.e., the information supplied by the user, from the data base. The generator then automatically creates a .swf file from the .swt file which is shown to the user. However, the generator may also create a .exe file (or other format) from the .swt file if desired.

Following operation 426, a complete presentation has been created. The final presentation may be delivered to the user in many ways, such as by download, email transfer, stored onto CDs or other memory devices and shipped to the user, stored on a web page for the user, etc.

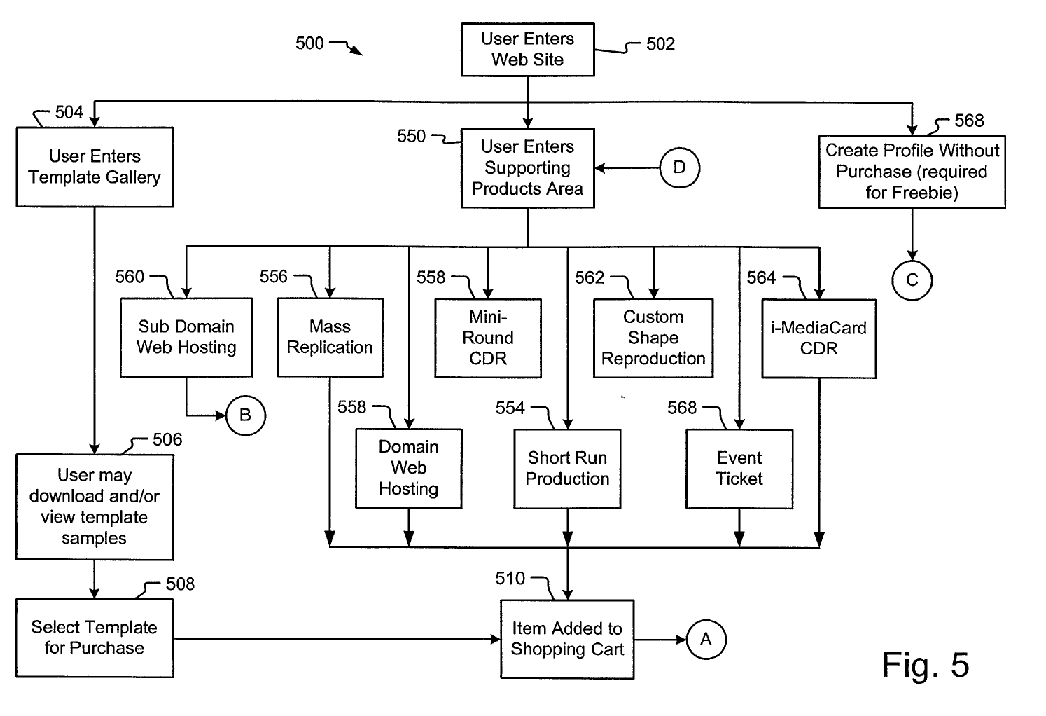

FIGS. 5, 6, 7, 8 and 9 represent a more detailed flow chart showing the process operations in a specific embodiment of the invention. The process begins at step 502 (FIG. 5) wherein the user enters the corresponding web site. The user enters this web site typically through conventional means such as through the use of a browser 302 (FIG. 3).

The user then has several options. Typically, a primary option will be to enter gallery at step 504 wherein the user enters the template gallery. The template gallery is where different templates are shown to the user. The next step, load step 506 allows the user to load and/or view template samples. At this step, the user may load a template to view its general structure. This step may involve the downloading and running of a flash file comprising the template on the client computer system. The flash file is a presentation that doesn't have any (or just generic) user-type information. This allows the user to have a satisfactory understanding of the template, and eventually what the final presentation will look like when complete, if that template is chosen.

The next step involves choosing the template, at step 508. Of course the user doesn't have to choose a template. If no template is chosen, the user can go back to the first web page. However, if a template is chosen, the item is added to the “shopping cart” at step 510. The shopping cart is an indication to the server computer system that the user has selected an item for purchase. Shopping cart functionality is a conventional procedure.

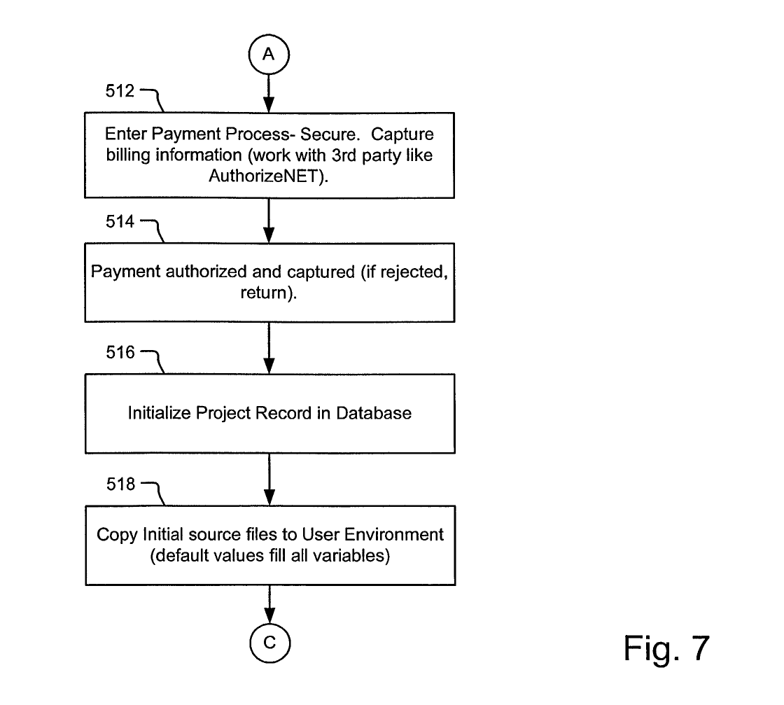

Once an item has been added to the shopping cart at 510, the payment process begins at step 512 (FIG. 7). Step 512 involves asking for, and receiving billing information, such as credit card numbers, etc. from the user. Following the receipt of this information, a call is made, preferably by the computer, to the credit-card company to gain authorization of credit. If the credit-card company refuses authorization, then the process displays such information and can jump back to the entry screen at 512 or alternatively out of the system entirely. It should be noted that the entire payment process might alternatively be done at a later time, such as following the template editing procedure but preferably before giving the user any finished product. Moreover, the payment process is fairly conventional and may typically involve third party vendors.

Following the step of authorizing credit at 514, process 500 continues with step 516 which initializes a product record in database at 516 and then copies initial source files to user environment at step 518. At this point a record has been created, a number has been assigned to the proper portion of the database for the user. In essence, a new project exists. Moreover, step 518 stores default values in the record. Some of the default values are related to the selected template, others are simply blank or default values. That is, each template has hundreds of variables that goes with it, e.g., the text that goes on page one and the picture that goes on page 50, etc.

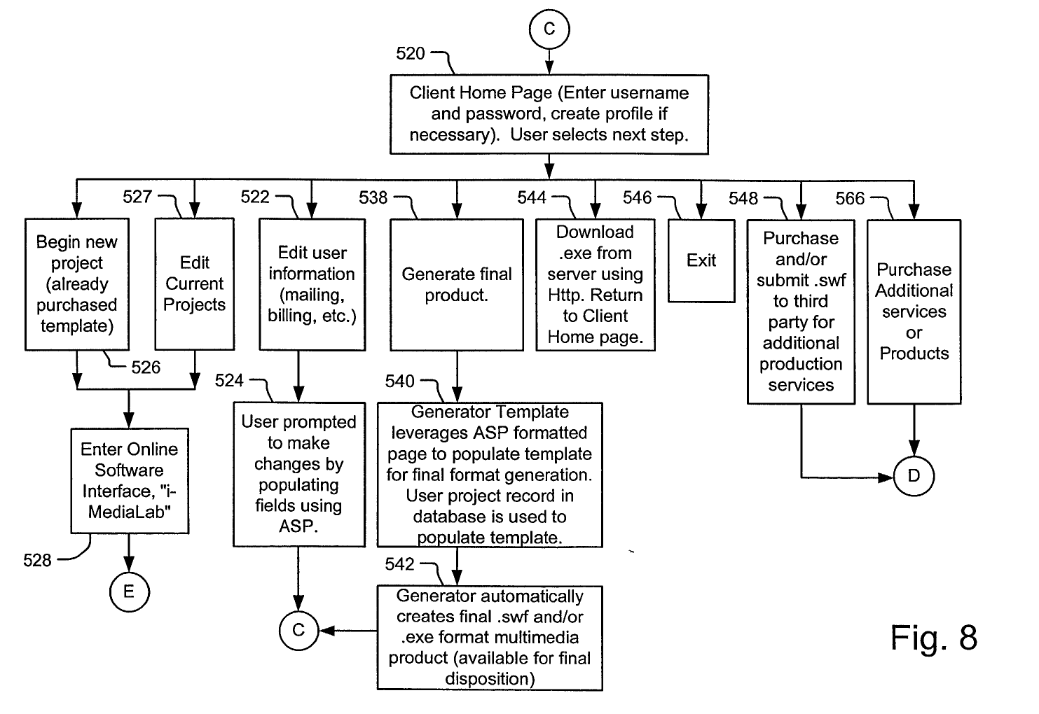

Once the record has been filled with default values, the user then enters client home page or client project page 520 (FIG. 8). At this page, the user enters a user name and password unique to that user. If there is no account set up for the user, this page allows for creation of such an account. Providing a user name and password allows a level of security. In theory, the user can enter their name and password prior to the template selection process (steps 504, 506, and 508—FIG. 5), or prior to the purchase authorization steps 512 and 514 (FIG. 7). Other options may also be apparent to those skilled in the art. For example, the process may have the user set up a name and password in order to build a ‘freebie.’ Giving a free presentation may be worthwhile if follow up work can be done using email or other entered user information. Moreover, keeping a profile allows tracking of affiliate referrals, i.e., if a user enters the website from an affiliate site and establishes a usemame/password, a commission can be paid to the affiliate on future purchases made by that user (even if the user does not come from the affiliate link in the future).

Within step 520, the user then is provided an option as to the next step that the user can take. For example, from this page the user can select to edit user information 522. This information may involve any user information such as mailing addresses, billing preferences, etc. If a user has created a profile and entered this information in a prior session, the user may want to edit or update the information. If the edit information option 522 is chosen, then the user is prompted to make changes by populating fields using a page(s) that communicates with the database via an Active Server Page (ASP) at step 524.

Assuming the user has selected a new template and added it the shopping cart, and assuming the payment has cleared, the user most likely chooses to begin new project step 526. Step 526 is to begin editing the newly purchased template to create a personalized presentation. Alternatively, if the user has performed some editing on a template and, for some reason, desires to make changes, the user may select to edit existing template 527. Either way, flow branches to step 528 wherein the user enters the online software interface. That is the online software interface module is started which eventually allows the user to enter their information into the record so as to formulate a presentation. This interface module is described above as the unique project area in conjunction with FIG. 4.

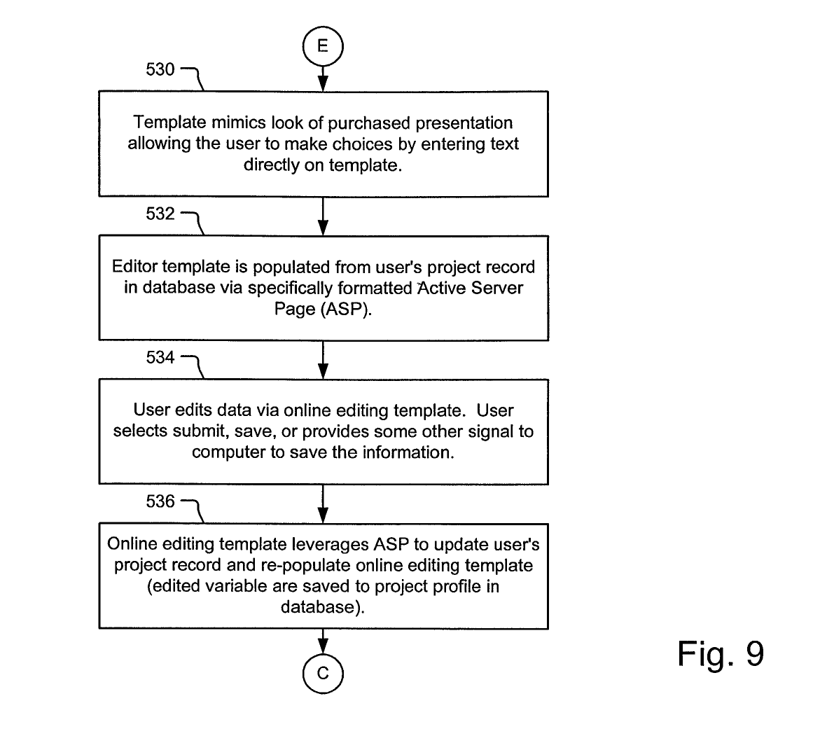

The online software interface provides a user-friendly environment so that the user can step through the whole presentation, inserting data where desired. At step 530 (FIG. 9), the process provides a template that mimics the look of the presentation, in a “what you see is what you get” format. Therefore, the user makes choices and enters text directly on the template. The software, in essence, displays the background images and provides a cursor at the location on the screen where text should be entered. When the presentation is complete, the text that is entered at that location is positioned at the same location, and formatted with the proper font, size, and color. The software also has interface controls for the user to select sound, images, and other features for their presentation.

In order to achieve this user-friendly interface, the background information is displayed as an editable object displayed at the client computer system. The ASP collects and formats any information entered with the editable object and delivers it to the database, additionally, the database is delivering updated information via ASP to the editable object. The editable object may be a Flash Object which is a .swf format file with editable text boxes and other edit interfaces (radio buttons, etc.) As an example, if the presentation is to have a running footer with the company's name, a control or text box is placed in the lower portion of the display. The user then enters the company name in that control to create the running footer. The ASP relates that choice to the database. This data is used later to instruct the ‘generator template’ to display the running footer as described by the user in the ‘editor template’ interface.

In an embodiment of the invention, an editor template is created. The editor template, as described above, is used just for the editing phase of the process and it mimics the look of the template that has been purchased by the user. The editor template looks very similar to the actual template, but in actuality it is quite different from a code level understanding of the two templates. There is no editable text box in the purchased template, as in the editor template. The editable text boxes allow user input, however, in the purchased one, no text boxes are necessary since the text is part of the presentation.

Operations 532, 534 and 536 are the steps where the actual template record is populated using user-entered information. Step 532 is where the machine changes the values in the database with information gleaned from the project record. If the user hasn't entered any information yet, the record will contain default values and these default values are used to populate the editor template. If, however, the user has made some changes (such as in step 534), the record contains information other than defaults. Either way, the system pulls values from the project record and populates the template from the record. Thus, the template is populated from the project record in the database at operation 532. When the project was initialized, step 516, default variables were stored in the template value fields. In essence, that was the original “population” of the template. Since the fields can change and do change, the template fields may be populated with updated values from the user's project record at 532. The use of ASP technology to update a server page from a database record is a relatively conventional method. Alternatively, other database-updating schemes can be used.

The user changes or adds information at step 534. At the end of editing or changing information at 534, the user indicates that the information should be saved by sending a signal to the server. The user may select a “submit” or “save” or even “quit” command. At this stage, the user may upload images, sounds, video or other information, e.g., stock tickers, chat modules, e-commerce functionality, banner ads, among others. The editor template requests the information and may even have help sheets to aid the user in performing such data entry.

As the user enters information, ASP gets the information and sends it to the database. When the user looks at the page again, the database uses ASP to update the page. From box 534 there are at least three options. First, the user can ‘save’ the information, which causes the ASP to take data to database and return user to 534 where fields have been updated from database via ASP. Second, the user can ‘preview’ the page which saves entered information to the database via ASP (similar to the save option) and then generates a .swf file using the generator (as discussed below). The .swf file is then shown on the user's display screen. This .swf file is just like the final file someone would get, except that it is watermarked so that it isn't useable for business. Moreover, the .swf is created the same way that a final .swf is created, i.e., ASP delivers data from the database to the generator (in this case the Macromedia Generator Server 2.0) and the generator compiles this data with the ‘generator template’ and generates the .swf file. Third, the user could exit and return to step 520 or almost any other location within the website topology.

Essentially, when one of these commands are selected by the user, the server saves the information at step 536. The information from the ASP page is used to update the fields of the database and the template is repopulated (showing the newly updated information). Essentially, there is a “two-way street” between 534 and 536 because when the user enters info at 534, the display seen by the user is immediately updated by that newly entered data when the user chooses to save, preview or exit. So, once the user enters data at 534 and selects save, preview or exit, the operation at 536 takes place. Further, if the user selected exit, then the process flow would branch back to step 520. Otherwise, by choosing save or preview, flow branches back to 534 wherein new information may be added. Storing information to a database using ASP is a known process. Importantly the data is stored in such a way that it can be reconstructed to place the text, graphs, etc. in the proper portions of the presentation.

When all information editing is complete, flow branches back to the project page 520 (FIG. 8) where the user selects the next option, such as to generate the final product at 538. In essence, the records have been updated but the final product has not been compiled. Operation 538 begins the process of compiling all the data received from the user and combining it with the template information to create a file in a format that can be used by the user.

Step 540 organizes the information (user and template information) in a predetermined format. Next, step 540 calls a generator template which leverages ASP information and populates the template for final formatting. The generator template is the same as the editor template in the way that it is populated (via ASP). The difference between the two is that the editor template allows for edits, e.g., a person can type their name in the name block and this information is taken to the database via ASP. To further the example, when a final presentation is generated, the name information is taken from the database via ASP to the generator template and placed in the ‘name’ field. However, this name field does not allow for edits. If someone wants to edit a completed presentation, they can open their data in an editor template, make changes, and regenerate a final presentation. In one embodiment, the final generated template is not itself editable.

Once the generator template has been populated at 540, the generator automatically creates a final-format file that comprises all the multimedia components desired by the user at 542. In an embodiment, the final-format file is an “.swf” file (“Shockwave format”) or other executable file on a disk that simply runs automatically when the disk is properly inserted into a computer system. In alternative embodiments, the auto-run feature is not part of the final product. Additionally, the final product does not have to be in .swf format, but may be in other formats such as .exe, among others. The several .swf files, and the executable file(s) are the final products, and although they look similar to what the user sees on the editor template, they are different in that they are non-editable compilations of all the information. There is no opportunity to edit the .swf file and new files must be generated if changes are made. Besides executable files that start when the disk is inserted in a computer, the .swf file can be modified to create a web page file that runs when a user visits the web site. Yet other types of files can be created from the .swf file; these choices are up to the user. For example, if the user is going to use this product on a CD, the file may contain an “exit button” so that a viewer can stop the presentation. But, on the other hand, if the user is going to use the product on the web, the exit button may not appear since stopping the presentation may not be an option. In an alternative embodiment, the generator is programmed to automatically create different .swf files having these different characteristics. The user doesn't see or know that these several different files exist, but the correct one is used when the user actually selects which result is desired.

In an embodiment of the invention, the user may generate a final product (steps 538, 540 and 542) many times for each purchased template. Alternatively, restrictions may be imposed on the user. Such alternatives are governed by the web site program module, which may be modified by the system administrator.

Creating the final-format file involves compiling the data that has been organized by the generator template, and supplying it to a complex software module. The software module compiles the information in a known manner. For instance, the software module may be Macromedia® Generator Server 2.0 or some other software program that is adapted to receive a data file having all the necessary information to create a final-format file. Since the template includes most of the programming necessary to create the file, the addition of user data completes the necessary information. In an embodiment of the invention, the server computer system performs the final-format generation. Alternatively, the client computer system performs some of the processing.

Once the final-format file (e.g., the .swf file) has been created at 542, flow branches back to the client project page, e.g., operation 520 where the user may select from several options, such as downloading the file 544. Step 544 allows the user to download the .exe file using the HTTP technology of the Internet, or the file could be emailed to the customer or otherwise delivered electronically to the customer, e.g., by using FTP or email. Typically, if the user has not created a final format file at 542, the download file option may not be available to the user. This step may blocked once a file has been downloaded, such that the user may only download one file per each template purchased as discussed above with respect to final file generation. The file that is downloaded may be an executable file that does not require any other programs. In alternative embodiments, the .swf file is provided directly to the user. If the .swf file is provided, then some other programs are required to actually run. Typically, if the user wants to create a file that runs automatically, the code that carries out this feature must be added to the .exe file after it has been created. This operation takes place prior to download or prior to burning the file into a CD. In yet another embodiment, a separate autorun file may accompany the .exe file, such as a .inf file. The .inf causes the automatic execution of the .exe file upon some triggering event, such as an initial access to of the file.

Alternatively, the file can be modified prior to downloading. For instance if the .swf file is to be a file that executes automatically, or one that is suitable for posting on the Web, etc. the user may select these options prior to downloading. The web site program module provides these options and, if selected, calls the necessary programming modules to carryout the modification. Once complete, the user may download the file. Once the file is downloaded, the user may exit the system at 546, if desired.

In an embodiment of the invention, other options for the user also exist. Once the final-format file has been created at 542 and flow branches back to the client project page 520, the user has many options besides downloading the file. For instance, the user may elect to purchase or submit the .exe file to an outside vendor for additional production services at 548. An outside vendor may be electronically connected to the web site so as to receive such requests. In essence the outside vendor can use the .exe file to create many products. Hence, once the user selects the additional services option, flow branches to supporting products area of the web page at 550 (FIG. 5). From this page, the user may select which services the outside vendor should perform. Exemplary options include copying 552 the file onto a mini-round CDR for the user; short run production 554; or mass replication 556, each relating to the copying of the file onto a few or many CDs for the user and then mailing the same to the user. Yet other options include allowing the user to set up on a web site of their choosing either on their own domain 558 or on a subdomain of the current web-site 560. Additionally, from this page, the user can select other products such as specialized shapes for the CDs 562. Exemplary shapes include the i-MediaCard® 564 or Event Ticket CD™ 566. It should be noted that many of these features can be purchased with the user simply uploading files of their own, i.e., they can be purchased independent of the newly created file.

With the exception of sub-domain hosting 560, discussed below, choosing options from the products area 550 allow the user to add the item to the shopping cart 510. Once the item is added to the shopping cart the authorization process is completed as discussed above. Eventually, the user is transferred back to the client project page 520 where the user can exit 546 or choose other options discussed above. It should be noted that the user may opt to purchase additional services and products 562 at any time the user is in the client home page 520, which leads the user back to the supporting product page 550, which is discussed above.

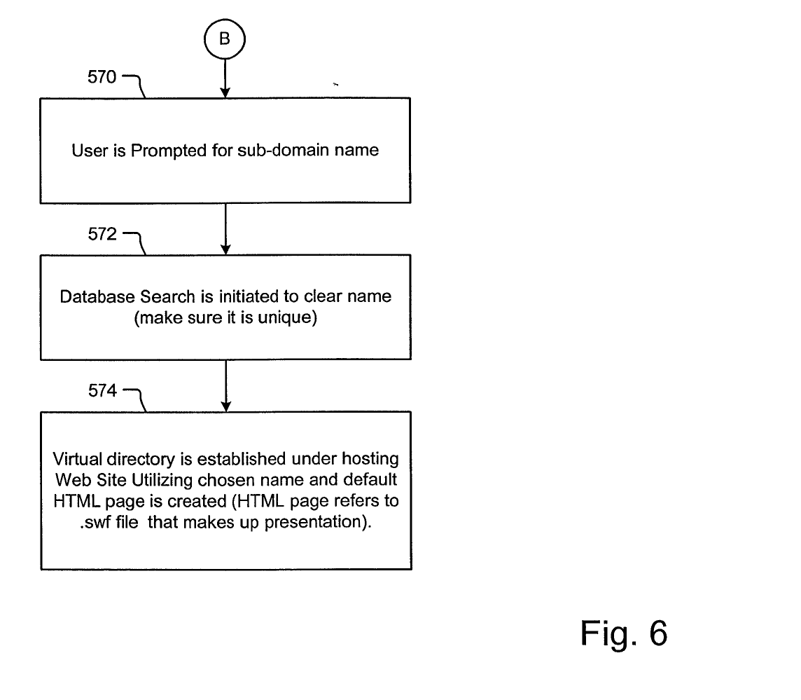

With respect to sub-domain hosting, the web site allows for the user to set up a web site as part of the present web site, just with a sub-domain name. Once the sub-domain option is selected at 560, the user is either prompted for a sub-domain name at 570 (FIG. 6). The system then checks the database of sub-domains on the server and determines if the name is unique and not taken by another at 572. If the name has been taken the user is prompted for another name. This process (steps 570 and 572) continues until a name is chosen. In an alternative embodiment, instead of allowing the user to select a name, a name is simply assigned by the system. Once the name has been determined, step 574 sets up a virtual directory under the hosting web site using the new name. Additionally, a default web page is set up, wherein the default page references the .swf file that has been created, assuming one has been created. If the user establishes a sub-domain, other .swf files can be uploaded to the web page. Moreover, the host web site can charge for this service.

Another feature of the project page 520 is that previously purchased templates are saved and may be modified at a later time. Typically, before the item can be downloaded, the product must be added to the shopping cart at 510. What is important to note is that the page 520 is, in effect, a personal web page for the user. Thus, different projects can be saved here, i.e., in the database indexed for this particular user, and accessed by the user at a later time for editing. In an embodiment, the presentation can be re-edited at a later date only by using our interface the interface used to generate the presentation. Alternatively, the presentation can be generated so that other commercial programs may be used to edit the presentation.

Having personal web pages for users allows the web site manager to insert focused advertisements or announcements, if desired.

As an alternative option to viewing the gallery upon entering the web site at 502, the user may elect to create a profile at 568 (FIG. 5) without going through the gallery at 504. In an embodiment of the invention this process may allow the user to generate a presentation for free. The free presentation may be as large or as feature rich as the paid-for presentation, yet in other embodiments the size and number of features may be limited. Typically, this path is allowed if the user was directed to the web site from a known entity. If so, the known entity can be determined due to the cookies on the user's computer system or using other tracking processes, such as “Identification Generated Re-direct.” The Identification Generated Re-direct process involves an affiliate sending prospects/visitors through an ‘invisible’ ASP page that attaches a session variable to the prospect. The session variable is attached to anything the visitor does while at the site. More specifically, it codes the user so that if they make a purchase of set up a username/password, the affiliate responsible for that visitor may be identified since each affiliate attaches a unique number to prospects. Thus, commissions may be paid to the known entity, typically an affiliate. If the user is satisfied with the options, the regular path is always open for use.

In another embodiment of this invention, a kiosk may be set up that contains the primary features of the server computer 104 and provides a user interface for the user. In essence, there is no network/Internet-type connection, the user simply works on the computer that provides the end product. In such a situation, many of the same technologies are used with preprogrammed templates, an editor template and a generator template. However, in that case the advanced ASP file protocols may not be necessary. For the most part, in the kiosk environment the database, and the generator are resident on the same system that the user visits. There is no communication over a network such as the Internet. ASP may therefore not be needed since there are other resource-friendly methods of delivering data to a database that may be resident on a single system such as the kiosk.

The computer system and process described above provides an online system of producing high-level, multimedia presentations. The process provides for a pay-per-use or pay-per-presentation system so that businesses need not purchase software. The use of preprogrammed templates provides many options to users, while reducing the overhead associated with fully customizing each presentation. Therefore, the cost for each presentation may be reduced significantly. Additionally, the time required to create a presentation is greatly reduced and since the invention may be placed online, i.e., on the Internet, users may connect from almost anywhere. Moreover, the final product can be delivered quickly and efficiently online.

The above specification, examples and data provide a complete description of the manufacture and use of the composition of the invention. Since many embodiments of the invention can be made without departing from the spirit and scope of the invention, the invention is defined by the following claims.

What is claimed is:

1. A method of generating an electronic graphical presentation on a computer system comprising:
displaying a plurality of sample templates, each sample template showing a possible presentation layout;
receiving a request to begin editing a selected one of the sample templates;
displaying an editor template, the editor template looking similar to the selected sample template and having editable fields;
receiving project information from a user;
storing the project information in a database relative to the editable fields of the editor template; and
supplying the received information to generator software to automatically create a presentation based on the information and the selected sample template.

2. A method as defined in claim 1 wherein the computer system is a client-server computer system having a client computer system and server computer system that communicate over a distributed network and wherein the user operates the client computer system.

3. A method as defined in claim 2 wherein at least one of the sample templates is custom designed for a predetermined user.

4. A method as defined in claim 3 wherein the custom designed template is only accessible by predetermined users.

5. A method as defined in claim 2 wherein the distributed network is the Internet.

6. A method as defined in claim 5 wherein the act of displaying an editor template further comprises:
creating an interactive web page that has editable fields, wherein the interactive web page looks substantially similar to a final presentation;
storing the interactive web page in the database;
associating the interactive web page with a sample template that may be selected by the user;
displaying the interactive web page following user selection of the associated sample template.

7. A method as defined in claim 6 wherein the acts of creating, storing and associating the interactive web page occur prior to the selection of a sample template by the user.

8. A method as defined in claim 7 wherein source files are transferred to the client computer system following the selection of the sample template such that the client computer system is used in the processing of information.

9. A method as defined in claim 6 wherein the distributed network is the Internet and the user enters a web page to choose the sample template.

10. A method as defined in claim 9 wherein the user logs in prior to editing the editor template.

11. A method as defined in claim 10 wherein unique user information is stored in the database relating to each user in a user profile.

12. A method as defined in claim 11 wherein project information is stored in the database relating to each project in a project profile, and each project profile is associated with at least one user profile.

13. A method as defined in claim 12 wherein the generation of the final presentation comprises:
accessing the project information in the project profile;
accessing the template information relating to sample template; and
combining the template information with the project profile information to generate a final presentation.

14. A method as defined in claim 12 wherein the final presentation is an executable file that the user can execute on a computer system.

15. A method as defined in claim 13, the method further comprising delivering the final presentation to the user, wherein the act of delivering comprises one of the following: downloading, emailing, or mailing the final presentation to the user:

16. A method as defined in claim 13, the method further comprising storing the final presentation on the distributed network such that the final presentation may be accessed and executed from a remote location.

17. A system for creating an electronic presentation using a distributed network, the distributed network having at least one server computer system and at least one client computer system and wherein the client computer system communicates with the server computer system of the distributed network, the system further comprising:
a database for storing information;
a plurality of sample templates stored on the database, the sample templates stored in an executable format such that when executed, the sample template demonstrates multimedia characteristics;
at least one editor template files stored on the database, wherein at least editor template is associated with at least one sample template;
a display module for displaying one of the editor templates
an information broker module for receiving project information associated with the editor template and storing the project information in the database; and
a generator module for combining the project information with the template information to create a final presentation.

18. A system as defined in claim 17 wherein the project information comprises multimedia information.

19. A system as defined in claim 18 wherein the system further comprises a disposition module for delivering the final presentation to the user, the disposition module delivering the presentation via the distributed network.

20. A computer program product readable by a computer and encoding instructions for executing a computer process for creating a topical data structure, said process comprising:
displaying at least one sample template, the sample template demonstrating a sample electronic presentation;
determining whether a sample template has been chosen for editing;
displaying an editor template in response to determining that a sample template has been chosen for editing, the editor template associated with the chosen sample template and editable fields;
receiving project information to be stored in relation to the editable fields of the editor template;
combining the project information with the template information to create a final presentation;

21. A computer program product as defined in claim 20 wherein the editor template mimics the look of the chosen sample template such that the editable fields appear substantially near the location in which the information will appear in the final presentation.

22. A computer program product as defined in claim 21 wherein the project information is stored separate from the editor template information.

23. A computer program product as defined in claim 20 further comprising delivering the final presentation to the user over a distributed network.
